(19) United States
(12) Patent Application Publication
(10) Pub. No.: US 2004/0215561 A1
(43) Pub. Date: Oct. 28, 2004

(54) Method and system for paying small commissions to a group

(76) Inventor: Michael T. Rossides, Scottsdale, AZ (US)

Correspondence Address: Michael T. Rossides, 11167 E. Mirasol Circle, Scottsdale, AZ, 85255, US

(21) Appl. No.: 10/424,190

(22) Filed: Apr. 25, 2003

(51) Int. Cl. G06F 17/60

(52) U.S. Cl. 705/40

(57) ABSTRACT

Here we disclose a method for enabling a seller to pay micro-commissions to multiple individuals who deliver a sales message to the same prospect. The main obstacle to paying a micro-commission is the cost of verifying that a sales message has been delivered by an individual. A second obstacle is the cost of transferring a micropayment efficiently. The inventive method overcomes these obstacles by paying referrers with a fair chance to win all or part of an amplified commission.

In simplified form the steps of the method are: (1) a seller enters a referral offer into a computer database system, (2) referrers then enter referral claims that identify a prospect and that represent claims on a potential commission, (3) the expected value (EV) payment process is used to “probabilistically amplify” the commission owed through a fair bet, (4) if a claim “wins” the EV payment bet process, the amplified commission is calculated and an inspector verifies the winning claim, (5) then, if the claim is found valid, the referrer who submitted the claim is paid his share of the amplified commission.

### CROSS REFERENCES

This specification was preceded by disclosure documents 468799, 477084, and 481613 (the relevant material begins on page 77). This specification makes reference to U.S. Pat. No. 5,269,521 concerning the expected value payment method.

### BACKGROUND

1. Field of the Invention

This invention relates to methods and systems for paying commissions, referral fees.

2. The Prior Art

A “sales referral” or “referral” means that a person, a referrer, recommends that another person buy from a particular seller or buy a particular product or service. Paid referrals, in which sellers pay for referrals, are common and go by many names, such as, “commissions,” “finder's fees,” “referral fees,” “spiffs,” and “affiliate fees.” The most recent innovation in the area of paying for referrals is called “automated affiliate marketing” in which a referrer puts an “affiliate link” on a website that leads to a seller's website. If an Internet user clicks on the link and buys from the seller's website, the referrer gets credited with an affiliate fee. This method is described in U.S. Pat. No. 6,029,141. A related patent, 5,991,740, describes a network for managing affiliates.

The inventive method is different from these and other referral payment methods because its object is different: to enable a seller to pay micro-commission to a group of referrers for a sale. No methods or tools developed to date enable micro-commissions to be efficiently paid to a group of referrers. All previous technologies have relied on paying an individual referrer for a sale. Further, existing methods accumulate definite payments, while the invention disclosed employs a probabilistic payment approach.

### OBJECT OF THE INVENTION

The object of the invention is to enable a seller to pay micro-commissions (referral fees) owed to multiple individuals who deliver a sales message to the same prospect.

### SUMMARY OF THE INVENTION

Here we disclose a method for enabling a seller to pay micro-commissions to multiple individuals who deliver a sales message to the same prospect. For example, a toy manufacturer might offer to pay people who ask a retailer to stock a particular toy. If the retailer buys the toy then a commission is owed to this group of “grassroots” supporters. Each supporter's share of the commission may be very small, a micro-commission.

The main obstacle to paying a micro-commission is the cost of verifying that a sales message has been delivered by an individual. A second obstacle is the cost of transferring a micropayment efficiently. The inventive method overcomes these obstacles by paying referrers with a fair chance to win all or part of an amplified commission.

The method comprises a set of steps executed by a computer database system interacting with users. In simplified form the steps are: (1) a seller enters a referral offer into the system, (2) referrers then enter referral claims which represent claims on a potential commission, (3) the expected value (EV) payment process of U.S. Pat. No. 5,269,521 is used to “probabilistically amplify” the commission owed through a fair bet, (4) if a claim “wins” the EV payment bet process, the amplified commission is calculated and an inspector verifies the winning claim, (5) then, if the claim is found valid, the referrer who submitted the claim is paid his fair share of the amplified commission.

This specification elaborates on this method. Separately, this specification describes a novel directory system that incorporates the method to incentivize users to ask sellers to advertise in the directory.

### BRIEF DESCRIPTION OF THE DRAWINGS

FIG. 1 is a flowchart showing a version of the inventive method in which the first random selection step occurs before a sale is registered.

FIG. 2 shows a representative form for entering a referral claim into a database system.

FIG. 3 is a flowchart showing a version of the inventive method in which the first random selection step occurs after a sale is registered.

FIG. 4 shows the end result of a process for producing payoff estimate statistics.

FIG. 5 is a flowchart showing the inventive method incorporated into a directory system, creating a payment feedback loop.

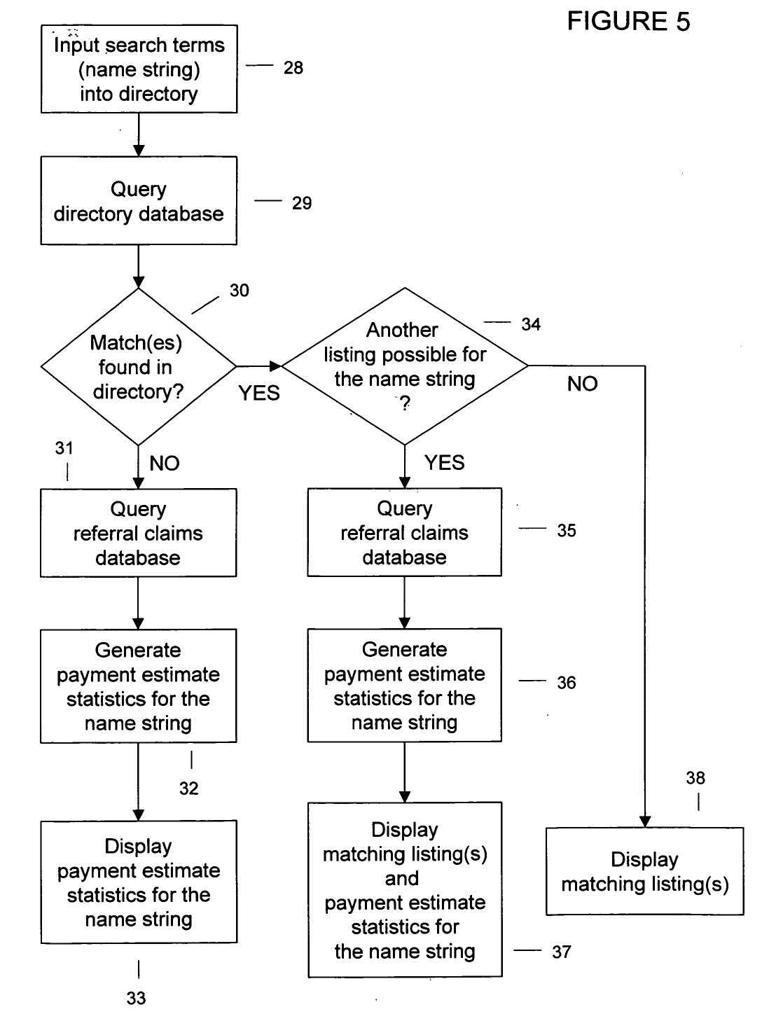

### DETAILED DESCRIPTION OF THE INVENTION

### Contents

Preface: How the Specification Is Written

Part 1: The Method Using Random Selection Before Registering a Sale

Part 2: The Method Using Random Selection After Registering a Sale

Part 3: Steps for Processing Multiple Referral Fee Offers

Part 4: Using Auditing to Prevent Cheating and Reduce Costs

Part 5: Providing Payment Estimate Statistics to Users

Part 6: Employing the Method to Populate a Commercial Directory

### Preface: How The Specification is Written

Referring to the Invention: Method for Paying Small Commissions (MPSC)

The full name of the invention is Methods and Systems for Paying Small Commissions to a Group. We will abbreviate it to Method for Paying Small Commissions (MPSC).

(Less formally, but perhaps more descriptively, we can call the invention by a Grassroots Referral Payment Method because the object is to enable a seller to reward a group of “grassroots” supporters who recommend the seller's product or service.)

For brevity's sake, we often refer to the MPSC anthropomorphically saying “the MPSC does so and so.” We rely on the reader to infer the meaning from the context—e.g., we might mean, “the computer system performing the MPSC does so-and-so.”

For simplicity's sake, we usually refer to the invention in the singular, although the full title of this specification states that multiple, related inventions are disclosed.

Two Basic Embodiments of the Method

We will describe two basic embodiments of the method, and then describe enhancements.

Definitions in Part 1 Apply to Part 2

We supply definitions in Part 1, which we also use in Part 2.

Variations Possible

While we supply sequences of steps, we do not restrict the invention to a particular, precise sequence, but realize instead that the steps themselves are paramount. Those skilled in the art will easily see where the sequence can be changed without altering the basic method itself. Likewise, we recognize that minor variations in the steps themselves can be made without altering the essential, inventive method.

Describing What is Novel

We strive to only describe what is novel, omitting obvious details.

### Part 1: The Method Using First Random Selection Before Registering a Sale

### OBJECT OF THE INVENTION

The inventive method enables a seller to offer multiple people a small sales commission for delivering a sales message to the same prospect. For example, a cable channel might want a local cable company to carry its channel and might offer people a commission for asking the cable company to carry the channel.

Illustrative Example of a Seller: A Commercial Directory called the Y-Pages

Throughout this specification, as our example of a seller, we will use the management of a hypothetical, online directory, which we will call the Y-Pages. We will assume that the management wants to pay people to ask advertisers to buy listings in the directory.

Initially we will consider the simplest case in which the seller makes an offer regarding just one advertising prospect, Sears. In other words, we will assume that the Y-Pages makes an offer to the public that whoever asks Sears to become listed on the Y-pages gets to split a commission if Sears indeed buys a listing in the Y-Pages.

Three Types of Users of the System

MPSC is performed by a database system interacting with three types of users:

Sellers. A seller provides the terms of a referral payment offer.

Referrers. A referrer submits a claim, which is then processed by the system.

Inspectors. An inspector decides whether a provisionally winning claim has met the conditions of the referral offer.

Name for a Referrer

For brevity's sake, we will sometimes call a referrer by the name Ray.

The Key to the Method: Using Expected Payments

The key labor saving technique of the MPSC is the use of the Expected Value Payment Method (EVPM) in the processing of referral claims. This means that referrers are paid with a chance to win a payoff that equals their commission amplified by a certain factor. This factor depends upon the probability set in an EVPM bet. In other words, referrers are paid in expected (in the mathematical sense of the term) payments, not definite payments.

Definition of an EV Payment Bet

In the EVPM, a payer offers a payee a bet in which the expected value (EV) for the payee is equal to the amount that the payer owes the payee.

The payoff on such a bet is always greater than the amount owed. The chances are set so the EV=the amount owed. And a random number selection is performed to determine if the payee has won and receives a payoff or has lost and receives nothing.

The payoff can be set as a specified amount of money, e.g. $500. If so, then the chances of a payee winning are set at: (amount owed)/(specified payoff).

Or, the payoff can be set as a multiple or the amount owed, e.g., 1000×. If so, then the chances of a payee winning are set at 1/multiple. Using a multiple is especially useful where the exact amount owed is yet to be determined.

In the MPSC, referrers submit referral claims, which represent claims on a potential commission. We say that these claims are “exposed to” an EV Payment bet when a random selection is executed to determine whether the claims are worth nothing or a payoff—either a static amount or a multiple of the amount of the claim.

(We note that payoffs and the probability of winning can be adjusted to accommodate profit margins for system operators, but that is a minor variation on the EVPM.)

Meaning of $1 EV

When we say that a person is paid with $1 EV, we mean the person is paid an expected dollar, in the mathematical sense, a dollar paid through the EVPM.

The Method Using Random Selection Before a Sale is Registered

In the first basic embodiment, referral claims are subject to a random, EV payment selection step before a sale is registered. This embodiment is especially suited to applications in which a sale has to be found and reported by human labor, rather than automatically.

What do we mean by that? Consider a situation that the invention addresses. Assume that the Y-Pages wants people to call Sears. Now assume that Ray calls Sears and recommends the Y-Pages to a marketing manager.

Now, Ray is only eligible to be paid money if a sale is made, so the sale event has to be registered somehow. In some situations, a sale can be registered automatically; in others, a person has to find out about the sale and report it to the system executing the MPSC.

If a person has to find out if a sale has been made and then report that sale, it is best to do that only when the stakes are adequately high. Thus, in the first embodiment, the method probabilistically amplifies the value of a referrer's claim. Then, it is cost-effective for a person check and report whether a sale has been made.

(We note that this embodiment can also be used in situations where a sale is registered automatically by a system that executes the MPSC.)

Steps of the Inventive Method, First Embodiment

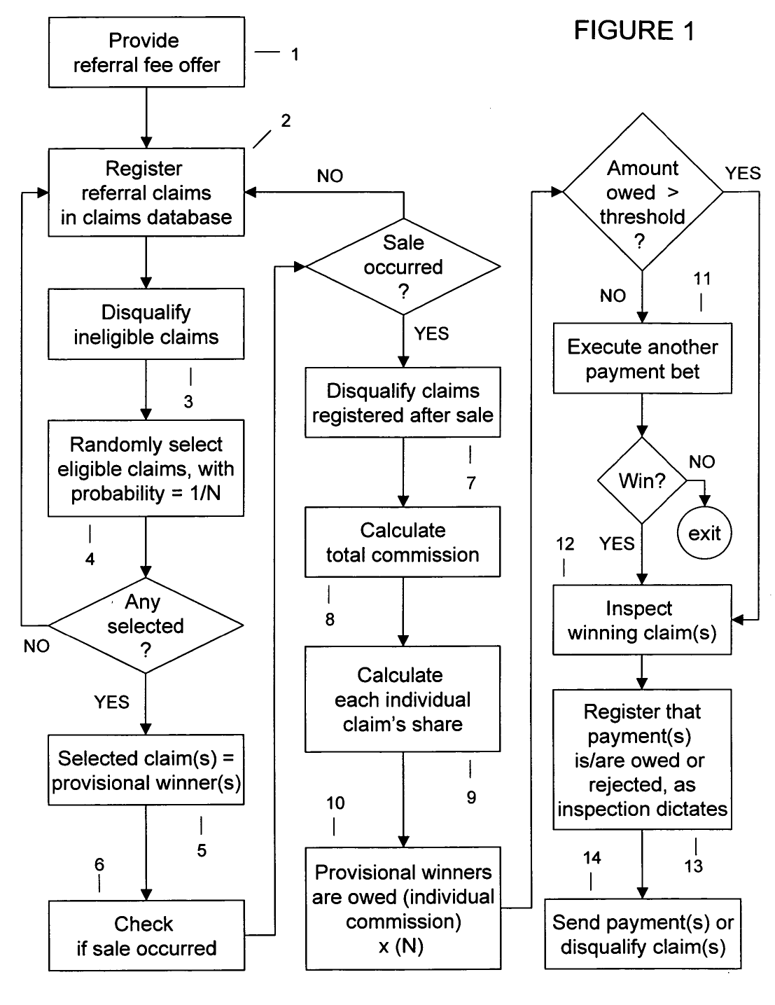

As shown in FIG. 1, the first basic embodiment of the MPSC comprises the following steps, which we list briefly, and then describe in detail:

1. Provide (1) referral fee offer.

2. Register (2) referral claims in a claims database.

3. Disqualify (3) ineligible claims.

4. Randomly select (4) eligible claims with a probability of 1/N.

5. If any are selected, they are designated provisional winners (5).

6. Periodically check (6) if a sale has occurred.

7. If no sale has occurred, continue registering claims. If yes, disqualify (7) claims registered after sale occurred.

8. Calculate (8) total commission.

9. Calculate (9) each individual claim's share of the commission.

10. Provisional winners are provisionally owed (10) (their individual commission's)×(N).

11. If the amount provisionally owed is above a threshold, go to the inspection step. If the amount is below a threshold, execute another payment bet (do this for each provisionally winning claim). If a claim loses the bet at this step, it is disqualified. If it wins, go to the inspection step.

12. Inspect (12) the provisionally winning, eligible claims.

13. If a claim is invalid, disqualify it (13). If a claim is valid, register the fact (13) and notify (14) a payment process that the referrer who entered the claim is owed the payoff from the payment bet(s) the claim was exposed to in the MPSC.

1. Provide referral fee offer.

In this step, a seller supplies a referral payment offer, all or part of which is registered (stored) by a computer database system that will then process referral claims. Accordingly, system for executing the MPSC will include means for enabling a seller to enter a referral fee offer.

Certain terms of the offer will dictate key aspects of the processing of the claims—for example, the payoffs of the expected value payment bets that the system executes will be dictated by the terms of the referral offer.

Certain terms of the offer will not affect the processing, but will be examined by an inspector when he checks whether the referrer has fulfilled them—for example, who the referrer must communicate with is a condition that does not affect processing, but that needs to be inspected.

Terms of a Referral Offer

Referral payment offers are infinitely variable. Here we list some of the kinds of terms that such an offer can include:

The product/service to recommend

For example, a service could be a “listing in the Y-Pages.”

The prospect—the company or organization—to target

The MPSC is designed to enable a seller to encourage Rays (“grassroots referrers”) to communicate with a company/organization prospect. Rays could be told to recommend the Y-Pages to any organization, or to a certain group of prospects, such as “Miami companies,” or to a single prospect, such as “Sears.”

Who to communicate with

For example, Rays could be told to speak to a marketing manger. Or they could be told to email, say, customerservice@ Sears.

When to communicate with the target

For example, Rays could be told to communicate during business hours. Or, they could be told to communicate by a certain date.

The commission amount or rate

For example, the Y-Pages could offer Rays a fixed fee, such as $2 EV. Or, it could offer them a percentage of the revenues generated from Sears.

The timing of the commission (e.g., monthly or lump sum)

For example, the Y-Pages could offer Rays a commission that is calculated one time only, or periodically. For instance, in cases where sales are ongoing, as in a monthly service contract, the commission can be accumulated over a period of time, or it can be calculated periodically.

The number of eligible referrers

For example, the Y-Pages may limit the number of Rays who can collect for a sale to Sears.

The splits among referrers

A commission can be split in an infinite variety of ways. The simplest is an equal division, but the Y-Pages could stipulate more complicated schemes. For instance, the first ten Rays might be paid more than the second ten Rays.

The terms of the EV payment bets executed in the MPSC

For example, the payoff can be stipulated.

The expiration period of the claims

For example, the Y-Pages could stipulate that a claim is invalid if a sale does not occur within 60 days of time that Ray makes his recommendation to Sears.

All such terms do not have to be entered into a system for executing the MPSC; they can be meta-terms that are understood by users.

(The system for executing the MPSC can include means for transferring payment from the seller to referrers. Such means can include the depositing of money into a seller account and then transferring it ultimately to a referrer. We do not elaborate on these aspects of the method because they are well known.)

What a Referral Payment Means in the MPSC

Let us elaborate on what we mean by “payment” in the MPSC. In the MPSC, when Ray submits a valid claim, he is entitled to a share of a sales commission, as specified by the payment offer. Thus, he is paid with this virtual share. For example, if the Y-Pages offers each Ray an equal share for calling Sears, up until a sale is made, and if 100 people call, then each is entitled to 1% of the commission.

But, Ray is not paid with a definite amount of money. He receives the right to participate in a bet in which his expected value=his share of the commission. This means that if he wins the bet, his share is multiplied by the factor implied by the bet. In other words, he receives an expected value payment that is equal to his share of the commission. Two examples will illustrate.

Illustration 1: Assume that Ray is owed an expected 1% of a $10 commission, which means he is owed 10 expected cents. Assume a bet is executed in which his probability of winning is 1/1,000. Then, if he wins, he is paid a definite $100.

Illustration 2: Assume a referral offer stipulates that each referrer, up to the first 50, will be paid with $1 EV if a sale is made to Sears. Assume that a sale is made and that. Ray is owed $1EV, his share of the commission. Then, a bet is executed in which his probability of winning is 1/N.

If he wins, he is paid $N dollars in definite money.

2. Register referral claims in a claims database.

In this step, the referrer submits a referral claim that the system stores as a claim record in a claims database.

A valid claim represents a share of a potential commission. In many implementations, the exact commission will not be known until a sale is made. And, if the sale is an ongoing one—for instance a monthly service contract—then the total commission may not be known until the end of a customer's relationship with a seller.

The MPSC can handle this kind of uncertainty because a claim entitles the referrer to a chance at a winning a share of the commission times a payoff multiple, provided the claim wins an EV payment bet selection. If the claim wins, and if there is a commission to be paid, then the commission can be determined, and the referrer is paid his share times the payoff multiple.

The claim can include some or all of the following information:

The referrer's identity

The prospect the referrer communicated with

The product/service the referrer recommended

The person the referrer communicated with

How the referrer communicated the recommendation

When the referrer communicated the recommendation

Where the referrer communicated the recommendation

When the claim is registered (stored) by the database system, it is timestamped.

Submitting a Claim

Ease of entering a claim may be crucial to induce referrers to use the MPSC. Thus, a key aspect of the MPSC is that it can incorporate methods for enabling referrers to submit claims easily.

These methods can be incorporated because a small amount of information may suffice for a claim. Moreover, tricks can be used make submitting claims easy. Easy input methods, such as leaving a voicemail, can be used. And, “compression techniques” can be used in which people are only asked the minimal amount of information necessary to verify a claim. For example, a referrer could enter only the initials of a manager that he spoke to. As another example, a claim might only include a phone number to identify a prospect. People-friendly compression tricks work because in the Verification Stage of the MPSC, the compressed information can suffice.

Let us look at three illustrations of how a claim could be submitted easily (these illustrations are not intended to limit the scope of methods for submitting a claim).

A. Submitting a Claim Through an Online Form

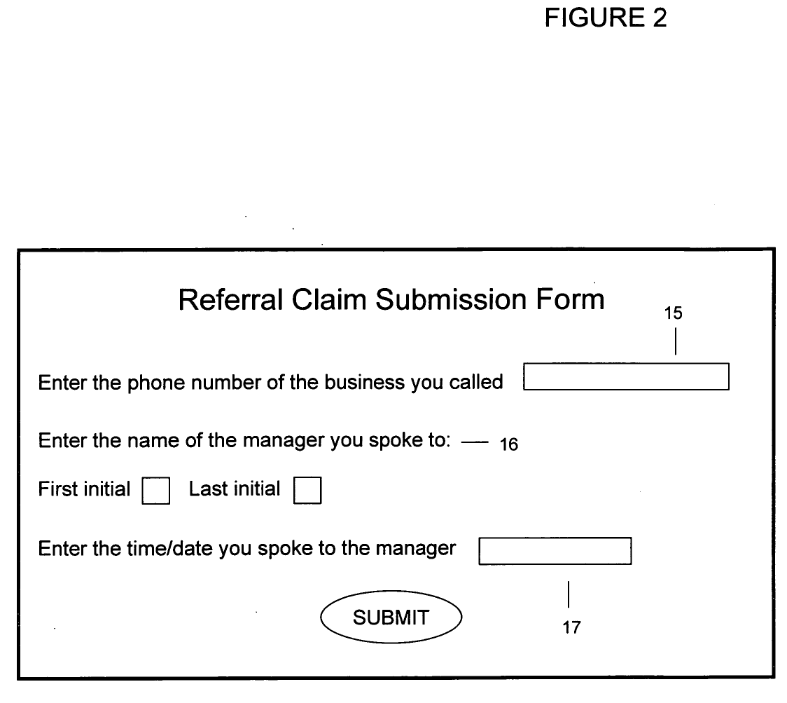

FIG. 2 shows a representative online form that could be used to submit a claim. Before entering claim data into the form, the referrer could be automatically identified by a cookie mechanism or the equivalent, so his ID data could automatically be added to the claim. The form includes a field for entering the phone number (15) he called, the abbreviated name of the person he spoke to (16) and the time/date (17) he called.

B. Submitting a Claim by Email

A short email message can also suffice as a claim. The email address could identify the referrer and a few lines of text could supply the rest of the claim data. The email address that the referrer sends to would include means for storing the email in a claims database.

Further, to make the MPSC even easier, the MPSC could enable the referrer to send an email recommendation to a prospect and a copy (a “Cc”) to an address for submitting claims. For example, the following message could be sent to service@Sears.com and a copy sent to claimsαgrassroots.com:

Dear CEO and Vice President of Marketing,

I would prefer that Sears advertises to me through the Y-Pages.

Thank you,

Ray

The content of the message, the sender's email address, the recipient's email address, and the timestamp could suffice as a claim.

C. Submitting a Claim Through an Voicemail

Another easy way to submit a claim is through leaving a voicemail message that is processed by a front-end system that can store such messages in a claims database.

A voicemail claim could be a simple message, even one that cannot be deciphered by a voice recognizer. For example, Ray could call an interactive voice response system (IVRS):

IVRS: Please tell us the company you spoke to, who you spoke to, and when.

Ray: I called Sears today and spoke to Tom Jenks, marketing manager, and told him that I thought Sears should use the Y-Pages.

If claims need to be matched up for a particular prospect, a phone number for the prospect could label a voicemail message. For example, if Ray entered Sear's phone number, then the phone number could label the message as a claim that Ray called Sears. Thus:

IVRS: Please use your keypad to enter the phone number of the prospect you called.

Ray: 800-GO-SEARS.

IVRS: Please tell us whom you spoke to.

Ray: I spoke to Tom Jenks, marketing manager.

As another example of how voicemail could be used, it is also possible for Ray to do a “conference call” in which one party is Sears (the prospect) and the other party is a voicemail system that captures Ray's call to Sears—this method is analogous to the email method above in which Ray sends an email recommendation to Sears (the prospect) and copies an address that receives and registers claims.

Similarly, with an appropriately programmed phone system, Ray could call a prospect and, upon terminating the call, could press a button on his phone that automatically calls a voicemail system for registering claims. The system could capture the previous number that Ray called.

3. Disqualify ineligible claims.

In this step, the system can use automated tests to ensure that only eligible claims have the chance to win EV payment bet payoffs.

There may be several different eligibility conditions that the system can check for at this stage. For example:

Duplicate submissions can be designated ineligible.

Claims that have already been exposed to an EV Payment bet can be designated ineligible. For example, a claim may be subject to an EV payment bet once a month. In this case, once it is subject to a bet, it would be ineligible for the monthly period, after which it could be subject to a new payment bet.

Claims that are expired can be designated “expired.” claims that are past a certain limit can be designated ineligble. For example, the Y-Pages may only offer the first twenty referrers the opportunity to share a commission. Any claim after that would be ineligible.

Disqualification of claims can be done at the inspection stage of the MPSC as well.

Disqualification tests can also occur at other stages in the MPSC. In other words, disqualification does not necessarily need to be done directly before an EV payment bet is executed for a claim.

4. Randomly select eligible claims with a probability of 1/N.

Periodically, eligible claims are exposed to a random selection in which their chance of being selected is 1/N.

Depending on the referral offer, a claim may be exposed to a random selection—an EV payment bet, that is—one time only, or periodically.

Periodic bets are suitable if commissions are periodic, e.g., monthly, and also if referrers prefer to find out periodically whether they have won or not.

Random selection can be done such that each claim is independently exposed to a random selection of 1/N, such that more than one claim can “win” the selection process. Alternatively, a group of claims could be selected with one claim “winning,” and then this winning claim can be subjected to second EV payment bet selection. For simplicity, we will assume that each claim is independently subjected to a selection of 1/N.

5. If any are selected, they are designated provisional winners.

The random selection is an EV Payment bet execution in which a winning claim is provisionally owed N times its original value—N times its share of a sales commission, provided that there is a commission and provided that the claim fulfills all the eligibility conditions of the referral offer. Thus, winning claims are designated “provisional” winners.

6. Periodically, Check if a Sale has occurred.

In this step, the system or a system operator or the referrer checks if a sale has been made, resulting in a commission being owed.

The system checks if it includes means for automatically registering a sale.

If the system cannot automatically register a sale, then a system operator needs to find out if a sale has been made, and report that fact to the system.

Alternatively, in certain implementations, the system can send an alert to the referrer whose claim is a provisional winner. The alert can ask the referrer to find out if a sale has been made and report that sale to the system.

7. If no, continue registering claims. If yes, disqualify claims registered after sale occurred.

If a sale has not occurred then the system can keep registering eligible claims.

If a sale has occurred, then no more claims are eligible to be paid off. Claims may have been entered after the sale occurred would be deemed ineligible.

There will often be a gap between the time a claim is submitted and the time of a sale. For example, let's assume that Ray submits a claim on Thursday, and it is a winner, so a person checks on Friday whether a sale has been made. If the sale occurred on Wednesday, Ray's claim would be disqualified.

We should also note that the terms of a referral offer might specify that the referrer's recommendation must take place a specified amount of time before the sale occurs. In this case, the system would disqualify all claims submitted after this time period.

8. Calculate total commission.

If a sale has occurred, the commission is calculated.

A commission may be set at a static amount, which means it does not usually have to be calculated. Often, commissions are a percentage of a total sale, of course.

But, in many sales situations, the total commission might not be known because the revenue from the sale may accrue over time as, for example, in the purchase of an ad listing that is paid monthly. Thus, as with any commission, it can be calculated for a particular period of time.

The MPSC can handle periodic commissions by executing payment bets periodically for a given claim. Alternatively, one payment bet can be made that applies to each periodic commission. Alternatively, a commission can be accumulated over time, and then the single payment bet result can apply to that commission. The point is that the method can accommodate commissions that are paid based on the ongoing and uncertain revenues from a sale.

9. Calculate each individual claim's share of the commission.

Each eligible claim is entitled to a share of the commission. For example, if 100 people contact Sears, and Sears buys a listing in the Y-Pages, and the commission is $100 per month, then each eligible claim is owed $1 EV per month.

To calculate an individual claim's share of the commission pot, the system must know how many eligible claims there are. This task can be done by counting the eligible claims in the claims database. However, there may be complications.

One complication is that all the claims that pass initial disqualification tests are not necessarily eligible because they may be invalid for a reason that can only be found by a human inspection. Yet, almost all claims are not inspected; only the winning claims are inspected. So, an estimate must be made as to what percentage of submitted claims are eligible. The MPSC can calculate this estimate using an adjustment formula that can use data from the claims database or sampling data collected by system operators.

Another complication is that a referral offer may stipulate that different claims receive different shares of the commission pot. For instance, the Y-Pages might offer to pay the first ten claimants more than the second ten. Payment offers are infinitely variable, which means that the formula for calculating an individual claim's share of a commission can be equally variable.

(A third complication arises when the system enables offers in which claims can be submitted for multiple prospects, in which case the system needs to distinguish claims made for different prospects, or different offers. We address this problem in Part 3.)

Thus, the MPSC will need to include a share calculation formula for determining each eligible claim's share—each referrer's share—of the total commission. This formula can use the claims data and the inspection data (see later steps) that the system registers.

10. Provisional winners are owed their (individual commission's)×(N).

Once an individual supporter's share is determined, then the provisionally winning claim has a value of the (individual's share)×(N).

For example, assume that Ray the referrer submits a claim for recommending the Y-Pages to Sears, and assume that 100 eligible claims have been submitted, and that Sears buys a listing for $100 a month, and that the commission rate is 10%.

Then the commission is $10 per month, and Ray's share is one hundredth, or 10 cents. These 10 cents are multiplied by N to yield Ray's provisional payoff.

11. If the amount provisionally owed is above a threshold, go to the inspection step. If the amount is below a threshold, execute another payment bet (do this for each provisionally winning claim). If a claim loses the bet at this step, it is disqualified. If it wins, go to the inspection step.

If Ray's initial, provisional payoff is too low, then it may not be cost-effective to inspect Ray's claim and transfer the payoff. So a second EV Payment bet can be made with a higher payoff, a payoff that justifies inspecting his claim and transferring payment.

For example, if Ray is owed an initial payoff of $20, a second bet may be made in which he has a 1/5 chance of winning $100.

Note: a threshold test may not be necessary in certain implementations.

12. Inspect the provisionally winning, eligible claims.

Assuming Ray's claim has won a large enough payoff, it is time to inspect his claim.

An inspector call up the claim data from the claims database, and checks the data to see if it is correct.

For example, Ray may have said that he spoke to Jane Jones at Sears to tell her to use the Y-Pages.

The inspector can check if Jane Jones even works at Sears and in what capacity.

The inspector then can approve or reject (disqualify) the claim.

(Since inspecting a claim requires labor, the MPSC can also include steps in which Ray is required to put up a deposit to guarantee that the claim is valid, or a fee to pay for the inspection.

This kind of payment encourages Ray to be honest. We do not elaborate on these steps.)

13. If the claim is invalid, disqualify it. If a claim is valid, notify a payment process that the referrer who entered the claim is owed the payoff amount from the payment bet(s) it was exposed to.

If he disqualifies the claim, the disqualification is noted in the claim record in the claims database. The referrer may be notified or not. (The method may include procedures for enabling a referrer to appeal the inspector's decision, but we do not elaborate on this possibility.)

If the claim is approved, the approval is noted in the claim record in the claims database. Ray is owed the payoff of the EV Payment bet(s) that his claim was exposed to. The approval is noted in the claim record. The system can transfer payment if it includes such means. We will assume that the system simply passes a message to a payment process that handles the well-known details of transferring a definite payment to a recipient.

Alerting Potential Winners

One feature that can be added to the MPSC is an alert step in which referrers with provisionally wining claims can be alerted that their claims are provisional winners. This kind of alert can increase the “fin factor” of using the MPSC.

Creating Additional Bets for Entertainment Purposes

Along the same line of thinking, an extra bet step can be added such that referrers whose claims have won an initial bet can be alerted that their claim has “won the first stage.” Any number such bets can be introduced for entertainment purposes.

### Part 2: The Method Using A First EV Payment Bet After Registering a Sale

Steps of the Method Using a First EV Payment Bet After a Sale is Registered

In the second embodiment we describe, an EV payment bet is first executed after a sale is registered. This embodiment is well suited is to applications in which a sale is registered automatically by the system that executes the MPSC.

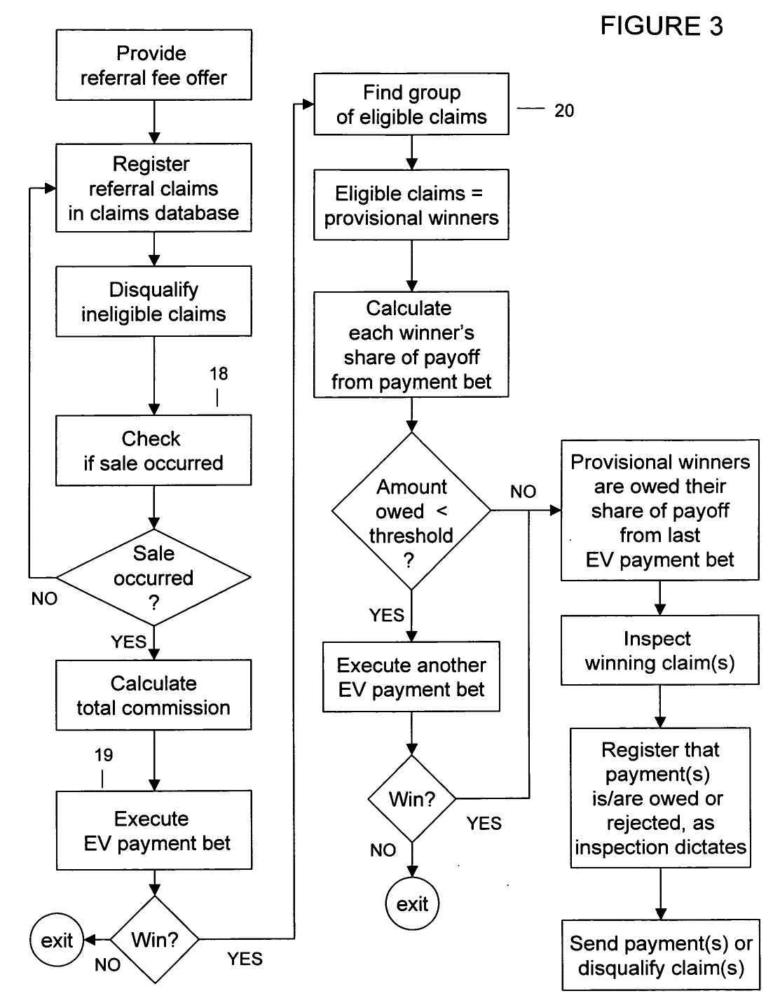

As shown in FIG. 3, the second embodiment of the MPSC comprises the following steps, which we list below. We will describe the steps that differ from those of the first embodiment.

1. Provide referral fee offer.

2. Register referral claims in a claims database.

3. Disqualify ineligible claims.

4. Check (18) if sale has occurred.

5. If yes, calculate the total commission.

6. Execute (19) an EV Payment Bet.

7. If the result is a loss, exit. If the result is a win, find (20) the claims eligible for payment.

8. Eligible claims are provisional winners.

9. Calculate each winner's share of the payment bet payoff.

10. If the amount owed is greater than a threshold, provisional winners are owed their share of the payoff. Go to the inspection stage. If the amount is below a threshold, execute a second EV Payment bet.

11. If the result is a loss, exit. If the result is a win, provisional winners are owed their share of the EV Payment bet payoff. Go to the inspection stage.

12. Inspect the provisionally winning, eligible claims.

13. If a claim is valid, notify a payment module that the referrer who entered the claim is owed the payoff amount from the payment bet(s) it was exposed to. If the claim is invalid, disqualify it.

1. Provide referral fee offer.

Same as first embodiment.

2. Register referral claims in a claims database.

Same as first embodiment.

3. Disqualify ineligible claims.

Same as first embodiment.

4. Check (18) if sale has occurred.

At this step the system, through automated means, registers that a sale has occurred. For example, if the Y-Pages is an online directory system, it could have means for enabling Sears to sign up, and therefore, it could register that Sears has bought.

The sale sets off a chain of events in which the commission is calculated and referrers are, possibly paid off.

The system would check periodically if a sale has occurred, and if a sale has not occurred, it will keep checking. For example, assume that the Y-Pages is an online, commercial directory that registers sales automatically. Then, if Sears signs up, it will register that sale. Assume, further, that the Y-Pages automatically registers revenue that accrues from the Sears listing.

5. If yes, calculate the total commission.

There is no difference here from the fist embodiment, but it may be worthwhile repeating that the commission can be calculated at over times, as revenues are realized over time, and not just directly after the sale is registered.

Continuing from the example in Step 5, assume that the Y-Pages calculates a sale of $1,000 in February, and then calculates a commission of $100.

6. Execute (19) an EV Payment Bet.

Here the system executes an EV payment bet in which the EV=the total commission. If a payoff is won, then all the eligible claims are owed their share of the payoff.

The payoff in this bet can be set as a static amount of money, or as a specified multiple of the commission.

Continuing from the example in Step 6, assume that a bet is set such that the payoff is $2,000: (the probability of a winning result would be 1/20).

7. If the result is a loss, exit. If the result is a win, find (20) the claims eligible for payment.

If the result of the EV payment bet is a win, then the system must know all of the eligible claims in order to calculate each claim's share of the payoff.

Continuing from the example in Step 7, if the result is a win, then all the eligible claims are owed their share of the $2,000 payoff. Thus, it is necessary to find all the eligible claims.

(If the system can search the claims database to find all the eligible claims, it does so. We assume that it can, if the claims database is only accommodating one referral offer. But, if a system must accommodate multiple prospects, or multiple offers from different sellers, then finding the eligible claims may bet more complicated. We take up this situation in Part 3.)

8. Eligible claims are designated provisional winners.

This step is the same as in first embodiment. However, it is worth noting that in this embodiment there may be a large number of provisional winners, whereas in the first embodiment, in most implementations, there will usually be a small number, often just one.

Continuing from the example in Step 8, let us assume that 50 referrers called Sears and submitted claims. Then each is a provisional winner.

9. Calculate each winner's share of the payment bet payoff.

Same as first embodiment.

(Continuing from the example in Step 9, let us assume that each claim is owed an equal share, which means that each is owed $2,000/50, which is $40.)

10. If the amount owed is greater than a threshold, provisional winners are owed their share of the payoff. Go to the inspection stage. If the amount is below a threshold, execute a second EV Payment bet.

Same as first embodiment.

(Continuing from the example in Step 10, if $40 is enough to justify inspecting the claims individually, then skip to the inspection step. If $40 is not enough, then another bet can be executed that applies to all the claims. Or, separate bets can be made for each claim. It is equivalent mathematically.)

11. If the result is a loss, exit. If the result is a win, provisional winners are owed their share of the EV Payment bet payoff. Go to the inspection stage.

Same as first embodiment.

12. Inspect the provisionally winning, eligible claims.

Same as first embodiment.

13. If a claim is valid, notify a payment module that the referrer who entered the claim is owed the payoff amount from the payment bet(s) it was exposed to. If the claim is invalid, disqualify it.

Same as first embodiment.

### Part 3: Steps for Processing Multiple Referral Fee Offers

Context

In Parts 1 & 2 we described the MPSC as a method that enables a seller to make and execute a grassroots referral payment offer, concerning a single prospect.

In practice, sellers will often make offers concerning more than one prospect. For example, a toy manufacturer may offer to pay people to contact any retailer who might be a prospect for buying toys. As another example, a commercial directory may offers to pay users for recommending the directory to any advertising prospect.

If there is more than one prospect, then a system that executes the MPSC needs to identify claims according to the prospects that they correspond to.

In practice, there will also be companies—sometimes called application service providers (ASP's)—that enable multiple sellers to use the MPSC, much as there are companies that handle coupon fulfillment for manufacturers. An ASP operated, MPSC system needs to be able to process multiple referral payment offers, of course.

In this part of the specification, we discuss steps that can be added to the embodiments of Parts 1 & 2, that enable a system to process claims for multiple prospects, and for multiple offers. The key problem to be faced is how to identify referral claims so that claims for the same prospect or offer can be matched up to yield the group of claims that share a commission.

Before proceeding, let us note that if a system enables multiple sellers to provide referral offers, then the MPSC will include well-known steps for establishing seller accounts that enable sellers to enter offers, edit offers, deposit payment and, transfer payment. We will not delve into these methods because they are well known.

Illustrative Case

To see the problem and the solutions concretely, we will illustrate with the example of an online directory, the Y-Pages, the makes the following offer to users:

Anyone who recommends the Y-Pages to a business that subsequently becomes listed will receive a share of a referral fee. The fee is 10% of the amount the business spends in the Y-Pages. This offer is open to the first 100 referrers who submit claims for a particular business. These referrers will share the fee for that business equally.

The Problem: Identifying claims and Offers

Claims need to be identified so that claims for the same offer and the same prospect can be matched up, so that each claim's share of a commission can be calculated (see Step 9 in Part 1, and Step 8 in Part 2). The problems are: How to identify which offer a claim corresponds to? And, how to identify which prospect a claim corresponds to?

At first glance, the solution appears simple. Why not just assign each offer and each prospect a unique ID?

That solution may not suffice. First, the list of prospects might not be known. For example, if the Y-Pages pays people for contacting “any business that might advertise,” the names of these businesses may not be known in advance by the Y-Pages.

Second, unique identifiers are usually not user-friendly. That is to say, it is often difficult for people to remember a string of digits or a precise, unique name. Yet, user-friendliness—the ease of entering claims—is critical to making the MPSC useful.

What We Will Describe in this Part of the Specification

As we delve into these issues, we will take the example of an online directory that makes the single offer above. We will not discuss the case of a system that handles offers from multiple sellers, because whether a system enables multiple sellers to make different referral offers, or a single seller to make one offer that applies to multiple prospects, the problem of distinguishing among claims is essentially the same. It is a match problem.

So, we will assume that the problem is identifying which prospect a claim corresponds to, so that the claim can be matched up with other claims for the same prospect.

For example, assume that Ray submits a claim that he contacted Sears. And assume that Rita submits a claim that she contacted Sears. Then, a system executing the MPSC must be able to identify that both claims correspond to the same business. It seems a simple problem, but it can be subtle. We will examine, one by one, the different ways that a referrer can report a recommendation: by email, by online form, and by voicemail.

We will reveal the problems involved in identifying a claim and describe solution steps that the MPSC can incorporate.

We will also discuss claims processing for each way that Ray can make a recommendation: in person, by phone, by online form, and by email.

We will then discuss steps for preventing the cheating that is possible when the name of a prospect or a product/service can be entered in different ways.

Finally, we will describe the use of an “extrapolation formula” as an alternative, or a complement, to matching a claim with other claims.

A. Submitting a Claim by Email

Let us first consider the case of Ray submitting an email claim saying that he recommended the Y-Pages by an email to Sears.

As discussed in Step 2 of Part 1, a very easy means for submitting this claim is to send a copy of his recommendation email to a claim registration address. This method should suffice in most cases to identify the prospect because the email address of the prospect, e.g., service@sears.com, or at least the domain name, e.g., sears.com, should uniquely identify a prospect.

This method works where the primary problem is identifying a prospect, but in cases where an offer or a product/service has to be identified, non-uniqueness problems may exist. These same problems exist when claims are submitted through online forms.

Next let us consider the cases of Ray submitting an email claim that he recommended the Y-Pages to Sears in person, by phone or by online form. These cases are equivalent to Ray submitting a claim through an online form too, though, because the same non-uniqueness problems apply. We discuss solutions below in the section on claims submitted through forms.

B. Submitting a Claim by Voicemail

A very easy way for referrer to submit a claim is via voicemail. We will consider three ways that a claim left as a voicemail can be identified as corresponding to a particular prospect:

Using phone numbers as identifiers

Using machine matching of voicemail claims

Human inspection of machine matched voicemail claims

Using Phone Numbers as Identifiers

Let us assume Ray makes a recommendation by phone and then reports that recommendation by a voicemail message left with a claims registration system.

For example, let us assume that he has called Sears. As discussed in Step 2 or Part 1, a very convenient way for Ray to identify the prospect—Sears in this example case, is to use the prospect's phone number. For example, he can call the claim registration system and enter the phone number for Sears.

But, a problem may exist with phone numbers, which is that many businesses have more than one number, so a phone number may not be enough to match up all the claims for a prospect. For example, Ray may use a local phone number to identify Sears and Rita may use a toll-free one.

The a referral offer may constrain the phone numbers—for example, the offer term may require a local phone number. If phone numbers are not constrained, solving the problem of multiple phone numbers may require that a system operator (a person) do some extra matching. Below, we discuss how human labor can be saved in this task, but first let us discuss automated matching of voicemail claims.

Using Machine Matching of Voicemail Claims

Another way to match claims according to prospects is for an interactive claims registration system to prompt Ray to state the name of the prospect he contacted, and then to use that name to match Ray's voicemail claim with other claims stored by the system.

Machine matching may be sufficient, depending on the implementation. Or, it might provide match data that an extrapolation formula (see Section E below) could use to estimate the number of actual matches stored in the system.

Or, machine matching might provide a set of matches that could be culled by a system operator. Below we discuss the case of using human labor—a system operator—to help match claims.

Human Inspection of Machine Matched Voicemail claims

In this section we assume that a system operator (Sis) is needed to assist in finding the matches for a claim. At this point, the MPSC will have executed an EV Payment bet in which there is a winner. There will be one or more winning claims, and it is necessary to find the othr claims for the same prospect, in order to make a share-of-the-commission calculation.

After the system database searches for matches, and outputs them to Sis, she can then assist in finding additional matches in the claims database and/or eliminating false matches.

First, we will assume that phone numbers are used to identify the prospect. We will imagine that, under the method of the first embodiment, that Ray has submitted a claim with Sears' local phone number, and that the claim has won. Now, we imagine that the system has found three other claims that have the same phone number as Ray's claim. But, Sis realizes that more than one phone number may be used for Sears. So, Sis may look in another directory to check phone numbers for Sears. Assume that Sis finds a few other phone numbers. Now, Sis can enter those phone numbers in to the claims database, searching for matches. For example, she might enter Sears' toll-free number, to see if any claims match that number. If Sis finds matches, say, two matches for Sears' toll-free number, then she can enter into the system that there are two more matches. This fact can also be registered in the claim record for Ray's claim.

Now, let's take a different situation. Let us assume that prospects are identified by speaking a name in a voicemail claim and that the names in voicemail claims are matched by machine (by a matching algorithm). Let us assume that Ray's claim has won and that the system finds 50 other claims that tentatively match Ray's claim. Sis can then listen to each tentatively matching claim and eliminate the false matches, leaving a set of actual matches.

Now, let's take a different situation. Let us assume that prospects are identified by text, by spelling that is. Let us assume that Ray's claim has won and that it has been matched up with 50 other claims. Sis can then review each potential match and eliminate, cull, the false matches, leaving a set of actual matches. Sis can go a step further, by entering other possible spellings into the claim database, looking for additional matches—Sis may be able to do this better than a machine in certain cases because human, common sense may be better suited to finding matches.

Now that we see how Sis can be used to assist in the matching process, the goal is to minimize the labor cost involved. Below we give two methods that can be used:

Set the EV Payment Bet Payoff High Enough

The first method is simply to set the payoffs of the EV payment bets high enough to justify the cost of having a human assist in the matching. For example, if the payoff is set at 10,000×the value of a claim, and a claim has a value of $1, then the $10,000 payoff may be worth the cost of human matching. How high the payoff needs to be depends on the implementation, of course.

Execute a Random, Pre-Selection Step of 1/Y Claims

Another way to reduce costs is to use a probabilistic counting trick. A random selection step can be taken such that registered claims are selected with a probability of 1/Y. The resulting set of claims can be used as the set that Sis uses to search for matches. The trick is that each claim found will represent Y other claims. For example, let us assume that Y=4. Then, it is fair to assume that each selected claim represents 4 claims, the one selected and three that are not. Thus, the set of claims that Sis has to examine is reduced by a factor of Y.

The preliminary random selection step acts not only as a counting step, but can also act as part of an EV Payment bet such that the selected claims are worth Y times their original value. Another EV payment bet step will be take to increase their value high enough to be paid off, but those claims that do not win this next EV payment bet step will still be used as the set of claims that are searched by Sis to find matches.

How high should Y be set? That will depend on the particular implementation. Y is chosen by system operators and should be based on empirical data. For example, if an average prospect is only contacted by 5 referrers, then it is not fair to set Y at a number much higher than 5, because the assumption that each selected claim represents Y claims will not be true.

This specification is not the place to detail the counting theory; let us simply say that an additional random selection step can be used in the MPSC for the purpose of establishing a reduced set of claims that are to be searched for matches, to find the number of claims that have been submitted for a given prospect (or a given offer, or a given product/service).

C. Submitting a Claim by Online Form

Trying to match text claims submitted by online form (or by email) involves the match problems we have already discussed: different spellings for prospects, different possible locations for prospects, different phone numbers (if phone numbers are used as identifiers), different spellings for products/services (if it is necessary to enter this information).

For example, assume that Ray and Rita both submit claims for referring a dentist, Dr. Dale Otagaki, to the Y-Pages. Ray might spell the name as Dale Ottaguki, while Rita might spell it Dr. Otogaki. Both have in mind the same dentist, but they have spelled it differently. There may be no standard way to enter such a name. Should Dr. be used, for instance?

A variety of tricks can be used to constrain claim submissions. We have said that using phone number is a powerful constraint. It does not suit all applications, however. The match solutions concerning text claims are really no different than those supplied in the discussion of voicemail claims. To wit:

the system can perform machine matching of claims

the system can perform machine matching, and a system operator can then add to or cull the list of matches, using claims records in the claim database.

D. Detecting and Preventing a Double Entry Cheat

In cases where a claim can be entered under different identifiers, a referrer may try to cheat by entering a claim more than once. For example, Ray might enter a claim for Bob 's Bikes and Bob 's Bicycles.

One way to prevent this cheat is to allow Ray to do it, but to penalize him severely if more than one claim is a winner.

Another way to prevent the cheat is to have the inspector do a lookup in the claims database to see what other claims Ray has submitted. Claims that appear to be duplicates can be nullified.

We should note that in some implementations, Ray might enter the same claim more than once in an honest effort to spell the prospect's name correctly. This multiple entry can be handled by having the inspector do a lookup and then discount Ray's payoff by a factor that depends on the number of duplicate claims he enters—i.e., if he enters two claims for the same prospect, his payoff can be discounted by 50%.

E. Alternative Approach: Using Formula to Guess the Value of a Claim

It is costly if a system operator has to take part in the process of matching claims, as discussed above. It would be cheaper if no human matching had to be done to find out each individual claim's share of a commission.

Ideally, we would like to enable Ray to simply leave a voicemail message, such as:

I called Sears at Fashion Square Mall and spoke to Tom Jenks the marketing manager and told him Sears should use the Y-Pages.

Ideally, no prefatory data enabling a machine to identify Sears would be necessary. The system processing claims could simply choose Ray's message, with a probability of 1/N. If the claim were picked, then it would be worth N times its share of the commission. A human inspector could verify the claim and not worry about matching it with other claims.

But, how to obviate the problem of finding all the other claims for that prospect, so that the system can calculate the share that Ray's claim deserves?

An alternative approach is to use an extrapolation formula that estimates how many other claims have been made for the same prospect, based upon historical, claim data. For example, through statistical analysis of claim records, system operators might find that the average prospect is contacted by 5 referrers, and consequently, they might create an extrapolation formula that assumes that each claim has a right to ⅕ of a commission.

An extrapolation formula would not have to be used instead of machine matching of claims; it could use automated match data. For example, if machine matching finds 3 matches for a claim, a formula might then extrapolate that there are actually 5 claims that match the winning claim. In fact, if machine and/or human matching of claims are used, it is likely that an extrapolation formula will be used to adjust the match figures—this use of a formula is analogous to the use of an adjustment formula, described in Part 1, Step 9.

We do not mean to oversimplify the idea of an extrapolation formula. The formula could be quite complex and depend on a variety of variables. For example, the number of referrers may depend on the size of a commission—i.e., more people may contact large businesses. The particular formula will depend upon the implementation and the experience of system operators, who will have to perform the statistical analyses of claim data. The formula will have to be set so that claims do not get paid too much, on average.

The point is that an extrapolation formula—one that estimates how many claims match another claim—is another way of calculating a claim's share of a commission.

In most cases, an extrapolation formula will be less accurate than a human assisted match process at finding a claim's proper share of a commission. But, the advantages may be so great that users will accept the seeming unfairness.

If a system that executes the MPSC uses an extrapolation formula, Ray could leave a message as in the example above, and not have to remember the phone number of a business or the exact spelling. His claim, if it is a winning one, could be deciphered by a human, who could verify whether Ray really did speak to Tom Jenks.

Such a formula can also be applied, of course, to claims submitted by email or online form.

### Part 4: Using Auditing to Prevent Cheating and Reduce Costs

The MPSC ensures that only valid claims get paid off because it includes an inspection step that verifies the data submitted for winning claims. Inspection takes place at last or second-to-last step of the MPSC. The most important purpose of inspection is to keep users honest, to ensure that they have actually made a recommendation, and are entering true claim information—for example, a referrer who truly makes a verbal recommendation will be able to enter the correct name of the person he spoke to. Invalid claims are disqualified. Operators of the MPSC could impose stiffer penalties, such as banning a referrer from participating in any other referral payment offer.

An alternative to inspection at the last stage of the MPSC is auditing—inspection before the result of an EV payment bet is known. With a certain probability claims could be audited at any stage, after they are registered in a claims database, not just after winning an EV payment bet. If the penalty for an invalid claim is stiff enough, the auditing could enforce honesty, and eliminate the need for an inspection only of winning claims.

If the MPSC employs inspection of winning claims, there is still a possible use for auditing. Rather than inspect all the winning claims, the method could audit a certain percentage, instead. Referrers who have winning claims could be required to pay a deposit guaranteeing that the claims are valid. If the deposit were large enough, and the probability of being audited were high enough, only honest referrers would rationally submit deposits, and so, only honest claims would be paid off. Thus, the cost of inspection, perhaps the largest cost of operating the MPSC, could be reduced.

(We note that if auditing at any stage is used to enforce honesty, then the role of the EV payment bets in the MPSC is to amplify the commissions so that transferring payment is worthwhile. However, if definite micropayments become cost-effective to do, then even EV payment bets themselves may not even be necessary to compensate referrers.)

### Part 5: Providing Payment Estimate Statistics to Users

Providing Payment Estimate Statistics

If the MPSC processes claims for and offer made for multiple prospects, then a useful feature is to provide potential referrers with information for estimating how much they will be paid for making a recommendation. Accordingly, the MPSC can include payment estimate formulas that use historical data from the claims database to arrive at useful payment estimate statistics. (Some such formulas may require data that are not generated from claims data, but that are entered into the system database by system operators.)

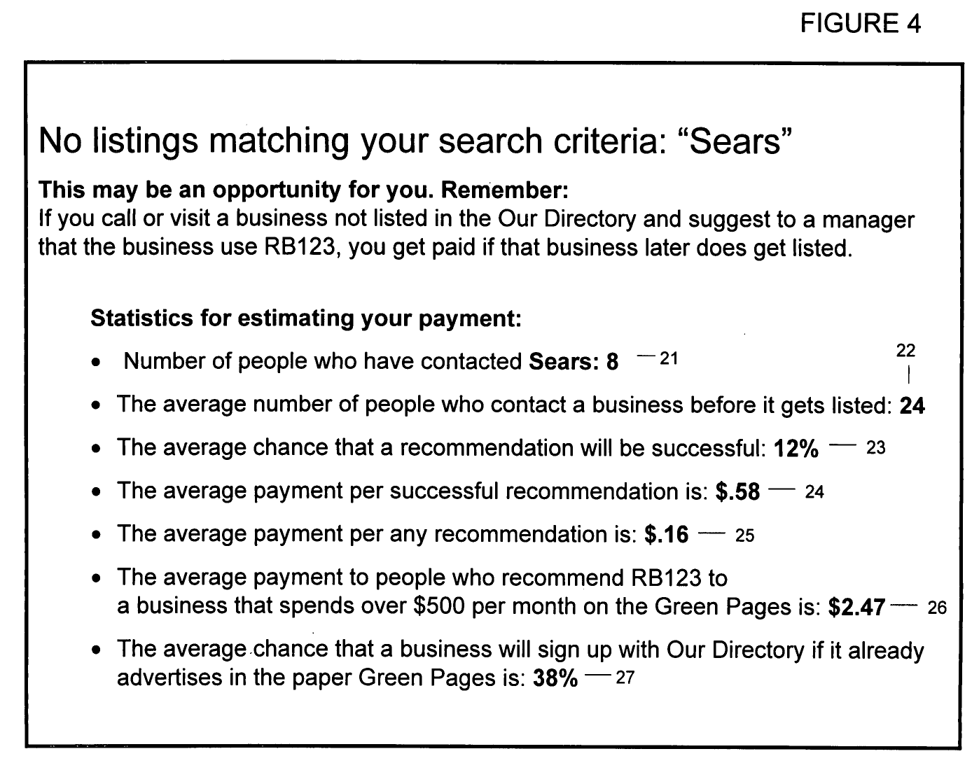

If the MPSC includes such formulas, it will also include steps for enabling users to see the statistics. The statistics may be displayed automatically by a system, or a system might enable referrers to query the claims database. Here we will list some of the kinds of questions that payment estimate formulas can answer, as shown in FIG. 4:

The number (21) of referrers who have already contacted a prospect

The average number (22) of people who contact a prospect before a sale is made

The average chance (23) that a sale will be made to a prospect

The average payment (24) for a successful recommendation

The average payment (25) for a recommendation, including unsuccessful ones

The average payment (26) to people who contact prospects with a given characteristic

The average chance (27) that a sale will be made to prospects with a given characteristic

In addition, a system operating the MPSC can show commissions paid, and being paid, for existing and past sales. For example, if the Y-Pages has paid a commission for a sale to Home Depot, the system could show how much the commission is. This information could help Ray decide when he is considering recommending the Y-Pages to Sears.

In addition to displaying such statistics, a system operating the MPSC can include means for enabling a referrer to enter his own estimate of the revenues from a sale. The system can include a formula for generating a commission estimate for him, based upon data in the claims database.

### Part 6: Using the Method to Populate a Commercial Directory

Business Problem: Populating a Commercial Directory

For companies trying to start a new commercial directory, one that charges advertisers for listings, an immense obstacle is the cost of populating the directory. Even if a new directory offers advantages, there is an enormous cost in trying to get the sales message through to advertising prospects. This problem is well recognized and has led to the demise of many a new directory, and has prevented people from trying to establish new directories. Not surprisingly, then, most of the leading Yellow Pages are those formerly owned by Ma Bell.

Of course, Yellow Pages are not the only kind of commercial directory. Directories of websites are another example, as are product/service catalogues. Consider trying to start a universal catalogue of products, not just a list of sellers of products, but also the products themselves, along with all the sellers who sell them. It is possible to create such a directory, but it is also obvious that, under current sales methods, the costs would be prohibitive.

Of course, the MPSC is not just for new directories; it can be used to populate an existing directory with more listings.

The MPSC Solution

In this part of the specification, we will consider how the MPSC can solve the problem of populating a commercial directory, especially an online directory. In our description, we will assume that the MPSC is incorporated into an online directory, i.e., the directory system will include a sub-system for processing referral claims according to the MPSC.

The MPSC can enable the directory to pay anyone, especially users of the directory, for recommending the directory to advertisers.

In fact, if a commercial directory incorporates the MPSC, an implicit feedback loop is created that provides users with either listings of businesses in the directory, or, implicitly, businesses NOT in the directory. That is to say, if a business does not appear in the directory, then the user knows that the business is a prospect.

(We note that in certain cases this loop could be made explicit, if the directory includes paying and non-paying listings. The non-paying listings could be labeled as “live prospects.”)

Let us illustrate with our Y-Pages example, which we will assume is an online phone directory.

Let us assume that the Y-Pages makes a grassroots referral payment offer to people who recommend the Y-Pages to businesses. Now, let us consider the sequence of events for a user:

Assume the user does a lookup by business name

The user finds that the business name does not exist in the directory

Thus, the user realizes that he may get paid for recommending the Y-Pages to this business (further, since he is doing a lookup in the Y-Pages, there is a reasonable probability that he planning to contact this business anyway—by calling, going in person, or visiting its website)

If the user contacts the business, he can recommend the Y-Pages

If he recommends the Y-Pages, he can submit a referral claim to the Y-Pages

The same process applies even if the user does a lookup by keyword. That is to say, if the directory returns listings for several businesses—say, car dealerships—the user may see that certain dealerships are missing, and that they are good prospects for buying ad listings.

Consider a hypothetical product catalogue, Product Pages, as another example:

Assume that the user enters the search term: Oakley sunglasses

The user finds a number of merchants listed under the term, but not the Sunglass Hut.

Thus, the user realizes that he may get paid for recommending to the Sunglass Hut that it get listed in the Product Pages under the product name, Oakley Sunglasses.

In this case, the product/service that Ray is recommending is not just the Product Pages, but the Product Pages and the search term, Oakley sunglasses. Thus, the Product Pages could offer to pay people not just for recommending that businesses advertise, but also for recommending search terms to those businesses. Accordingly, different referrers could be paid for referring the same business, but with different payments corresponding to different search terms.

Providing Payment Estimate Statistics—Creating Explicit Payment Feedback

Taking up the payment estimate features described in Part 5, we realize that we can create a explicit payment feedback loop within an online directory that incorporates the MPSC. Using the methods of Part 5, the directory can provide users with payment estimate statistics. Thus, as shown in FIG. 6:

A user enters a search term (28), for example, Roma Barbers

The directory queries (29) its database and does a lookup (30)

If no match is found, the directory:

Queries (31) a referral claims database

Generates (32) payment estimate statistics that correspond to the search term

Displays (33) the payment estimate statistics

If a match is found, and other listings are possible (34) under the search term:

Queries (35) a referral claims database

Generates (36) payment estimate statistics that correspond to the search term

Displays (37) the payment estimate statistics

If a match is found, and no other listings are possible under Roma Barbers, then the directory displays (38) the matching listing.

Payment estimate statistics that “correspond to the search term” may specifically use data on similar search terms, or less specific averaging data. One way to provide useful payment estimate statistics is to show the commissions being paid for similar listings, such as the listings under the search term. Thus, a directory can automatically show the commissions paid on a listing, or can enable users to do a query to find out. Another way is for the directory to track how many queries there have been for a particular search term and to show that number. The number can also be plugged in as a variable in a payment estimating formula.

We should not that in certain implementations, payment estimate statistics may only be averages that apply to all claims. Such averages could be posted on the directory's homepages or on a special page for showing the statistics. In other words, the statistics do not have to be shown along with directory listings.

We should also note that in many implementations, the directory system would not be able to know whether more listings are possible under a search term. So, the directory will either be set up as a directory in which there is only one paying listing per search term. In this case, the directory does not need to show payment estimate data along with a listing. Alternatively, in a directory where there is more than one possible prospect under a search term, or where the directory cannot detect whether more than one listing is possible, the directory will then default to always showing payment estimate data.

I claim:

1. a method for paying small commissions to a group, using an online computer database system, comprising the following steps:
providing a referral fee offer,
register referral claims in a claims database,
disqualifying ineligible claims checking if a sale has occurred,
if yes, calculating the Total Commission owed,
then, executing an expected value payment bet in which the probability of a winning result is 1/N and in which the payoff of the bet is (Total Commission)×(N),
if the result is a loss, exiting, but if the result is a win, finding the claims eligible for payment, and designating the eligible claims as provisional winners,
calculating each provisional winner's share of the payment bet payoff,
if the amount owed is greater than a threshold, said provisional winners being provisionally credited with their share of the payoff and going to an inspection step for inspecting said provisional winners,
if the amount is below a threshold, executing a second EV Payment bet for all the provisionally winning claims together or individually,
if the result for a claim is a loss, exiting, but, if the result is a win, crediting said provisional winners with their share of the EV Payment bet payoff, and going to said inspection step,
inspecting said provisionally winning claims,
if a claim is invalid, disqualifying it, but if the claim valid, notifying a payment module that the referrer who entered the claim is owed the payoff amount from the payment bets said claim was exposed to.

2. the method of claim 1 in which said database system enables users to provide referral payment offers for multiple prospects.

3. the method of claim 1 including a payment estimating formula for generating an estimate of how much a referrer will earn for referring a particular prospect, and in which said database system uses said formula to provide users a payment estimate for making a referral to prospect.

4. the method of claim 1, incorporated into a commercial directory such that referral payment offers are made for referring businesses that buy listings in said commercial directory.

5. the method of claim 1, incorporated into a commercial directory such that referral payment offers are made for referring businesses that buy listings in said commercial directory, and such that the method further includes a payment estimating formula for generating an estimate of how much a referrer will earn for referring a particular prospect that buys a listing.

6. the method of claim 1, incorporated into a commercial directory such that referral payment offers are made for referring businesses that buy listings in said commercial directory, and such that the method further includes a payment estimating formula for generating an estimate of how much a referrer will earn for referring a particular prospect that buys a listing, and in which said directory performs the steps of: enabling users to enter a search term, and if a listing corresponding to said search term is missing, returning a payment estimate for referring a business that buys a listing that corresponds to said search term.
